(19) United States
(12) Patent Application Publication
(10) Pub. No.: US 2010/0058632 A1
(43) Pub. Date: Mar. 11, 2010

(54) DISPLAY SYSTEM

(76) Inventor: Richard M. Love, Atanta, GA (US)

Correspondence Address: FSB Legal Counsel, LLP;Attn: Anthony J. DoVale, Suite 430-197, 885 Woodstock Road, Roswell, GA, 30075, US

(21) Appl. No.: 12/208,841

(22) Filed: Sep. 11, 2008

(51) Int. Cl. G09F 7/18; G09F 7/00

(52) U.S. Cl. 40/591

(57) ABSTRACT

A display system to mount to a selective portion of a motor vehicle. The display system may be used to display any number of graphical images. The display system is configured to selectively mount thereto various portions of the motor vehicle. The display system may be mounted to a metallic surface of the vehicle, to a hitch receptacle, to a license plate holder, or to a portion of the vehicle grill.

### FIELD OF THE INVENTION

The field of this invention relates generally to a display system. More particularly, the invention is a display system for use on several different areas on a motor vehicle.

### BACKGROUND OF THE INVENTION

In the automotive industry, consumers are constantly demanding new and innovative aftermarket products to enhance the aesthetic appearance of their vehicle. Over the past few years, the industry has witnessed vehicles being lowered to create what are known as “low riders.” There have been vehicles with neon lights installed on the undercarriage, as well as hub caps and rims that remain spinning after the vehicle comes to a resting position.

In the advertising industry, motor vehicles have been a target for inexpensive advertising for years. People use decals on their vehicles to promote products, sports teams, and businesses. Additionally, other forms of advertising are common, such as magnetic signs, banners, or flags that attach to a vehicles' window, or simply a bumper sticker.

People have been expressing their opinions and showing their affiliations via bumper stickers, magnets, vanity plates, and the like for years. They are always looking for innovative ways to show their “colors” on their vehicles. One of the issues with the aforementioned mediums is that they are either permanent or relegated to a particular use, such as bumper stickers.

### SUMMARY

A display system is disclosed that comprises a multitude of modalities to mount the system to a selective portion of a motor vehicle. The display system comprises a display surface to display any number of graphical images. In addition to the display surface, the display system also comprises a mounting assembly configured to selectively mount thereto various portions of the motor vehicle. For example, and not meant to be limiting, the mounting assembly may be mounted to a metallic surface of the vehicle, to a portion of the vehicle's window or window frame, to a hitch receptacle, to a license plate holder, or to a portion of the vehicle grill.

It is to be understood that both the foregoing general description and the following detailed description are exemplary and explanatory only and are not restrictive of the invention, as claimed.

### DETAILED DESCRIPTION OF THE FIGURES

The accompanying drawings, which are incorporated in and constitute a part of this specification, illustrate several aspects described below and together with the description, serve to explain the principles of the invention. Like numbers represent the same elements throughout the figures.

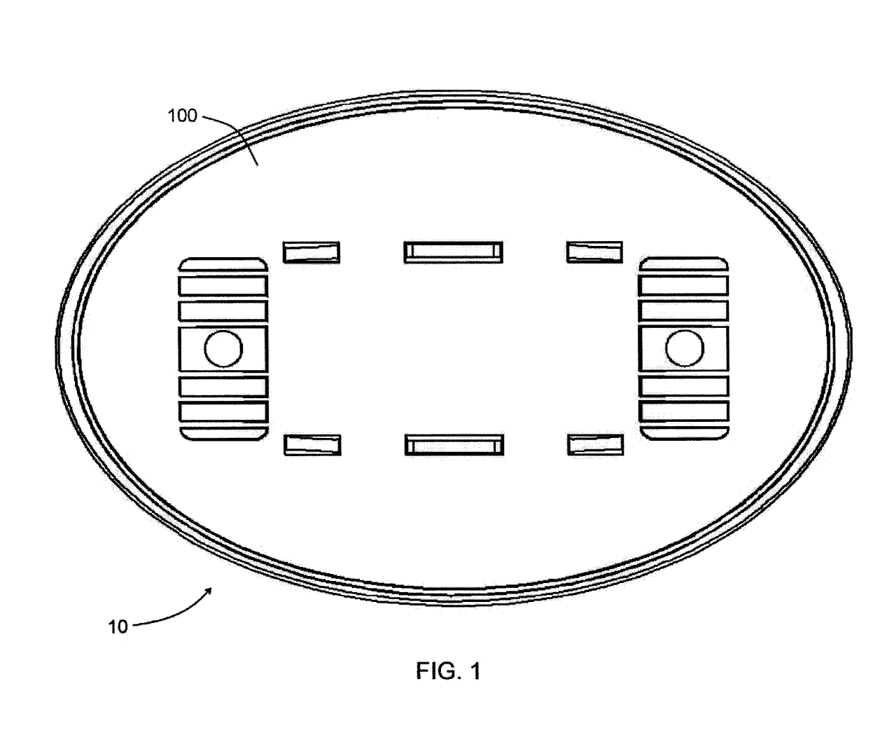

FIG. 1 is a front elevational view of one embodiment of a display system according to the present invention, illustrating the display surface.

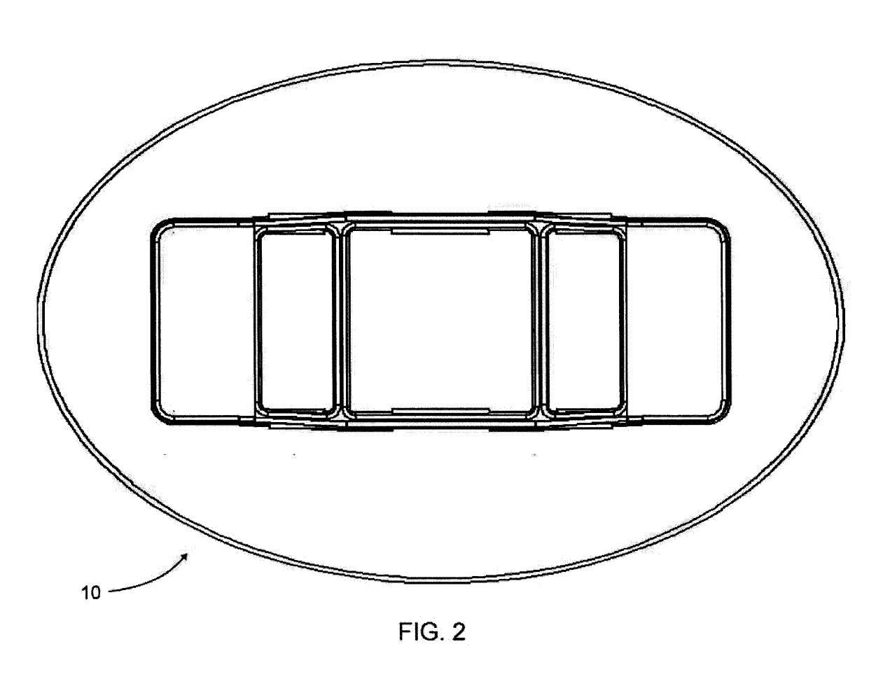

FIG. 2 is a rear elevational view of the display system of FIG. 1, showing the mounting assembly.

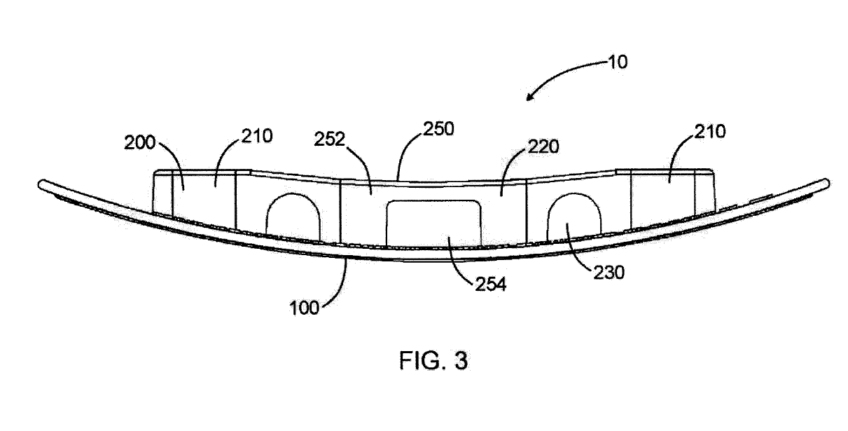

FIG. 3 is left side elevational view of the display system of FIG. 1, showing a plurality of strap bores and a retention hole; the right, opposite side, is a mirror image thereof.

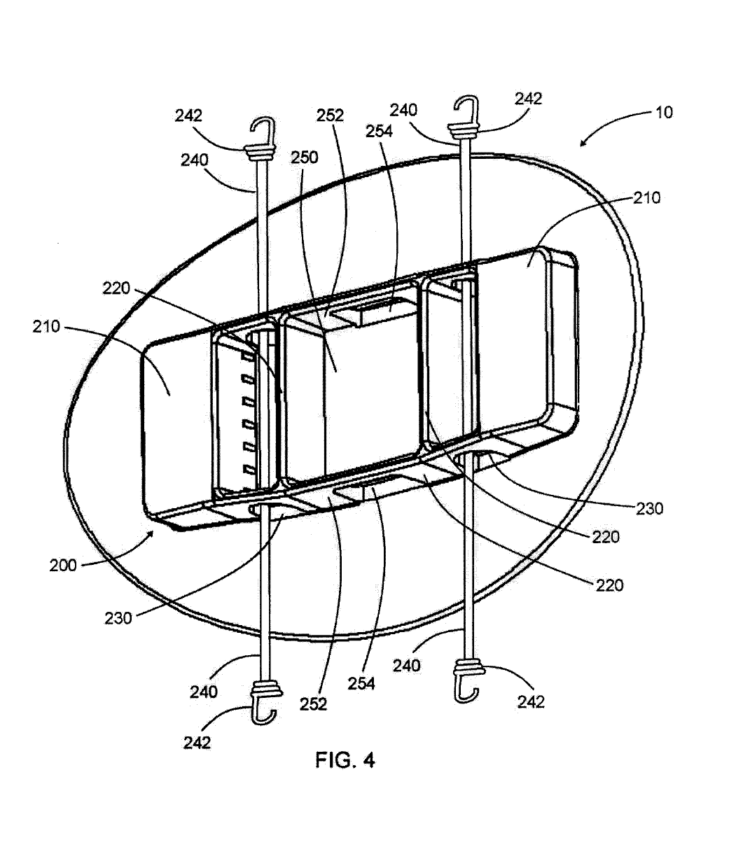

FIG. 4 is a rear perspective view of the display system of FIG. 1, showing a plurality of substantially elastic elongate members therethrough the strap bores.

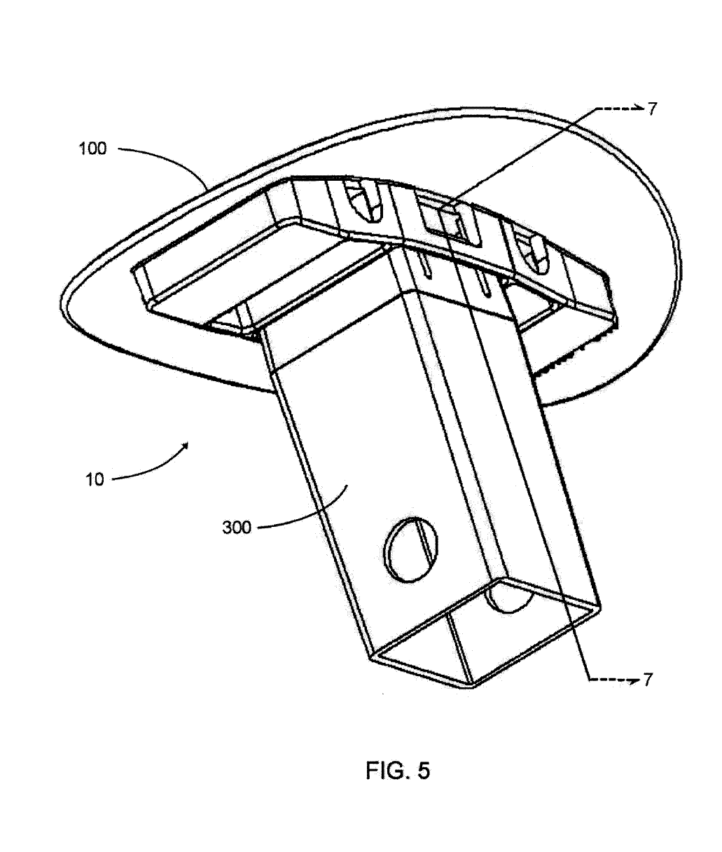

FIG. 5 is a front perspective view of one embodiment of a display system according to the present invention, illustrating a hitch member coupled with the display member.

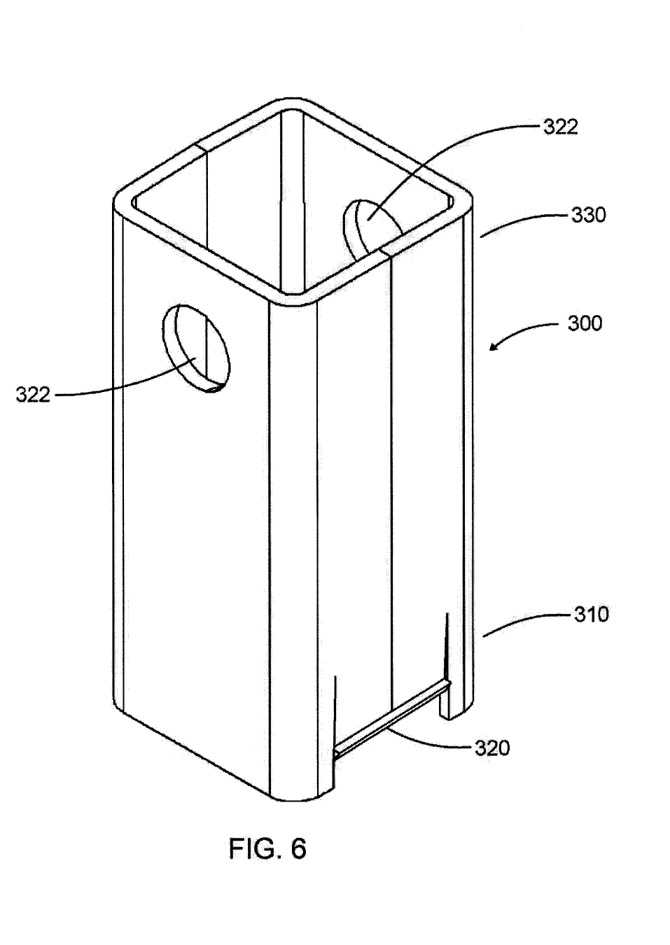

FIG. 6 is a front perspective view of the hitch member of FIG. 5.

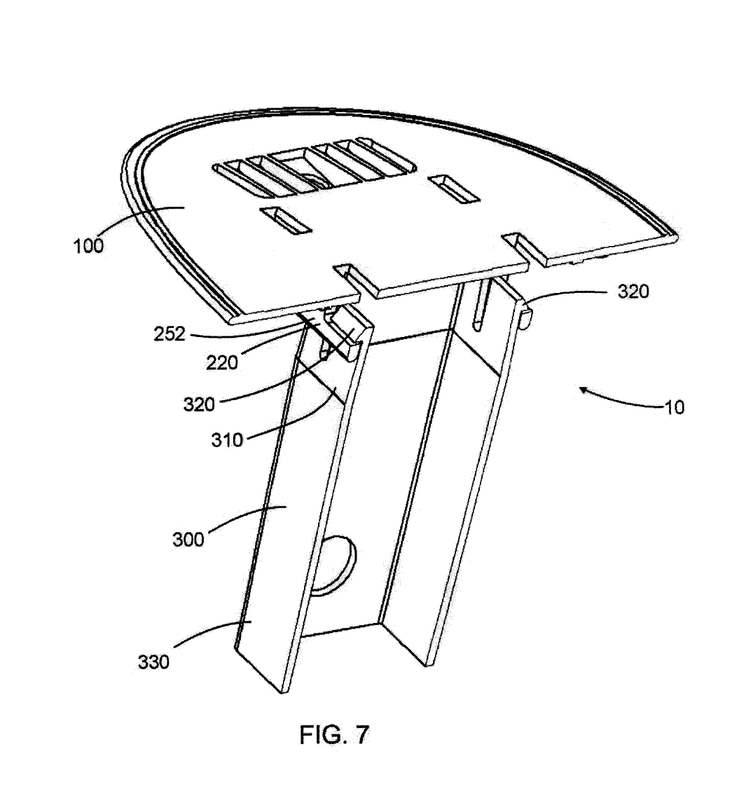

FIG. 7 is a cut away front perspective view of the hitch member of FIG. 5, cut along line 7-7.

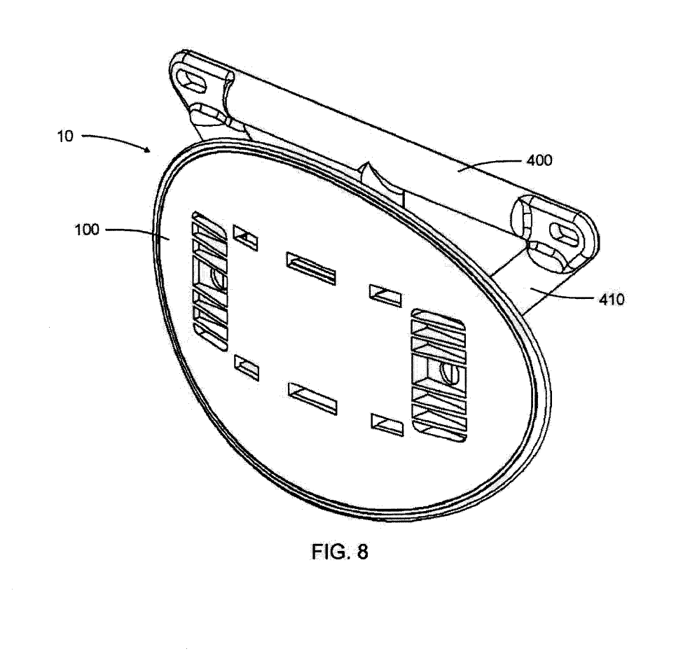

FIG. 8 is a front perspective view of one embodiment of a display system according to the present invention, illustrating a license plate adapter.

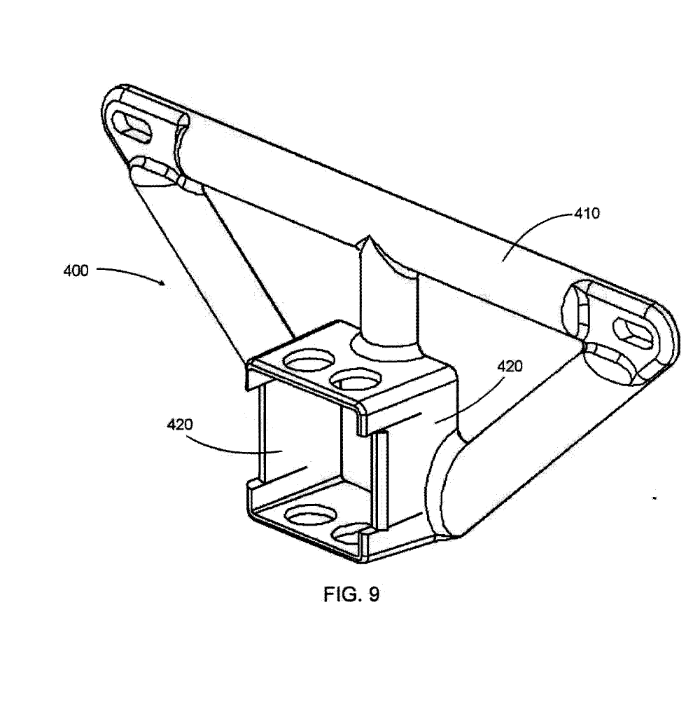

FIG. 9 is a front perspective view of the license plate holding of FIG. 8.

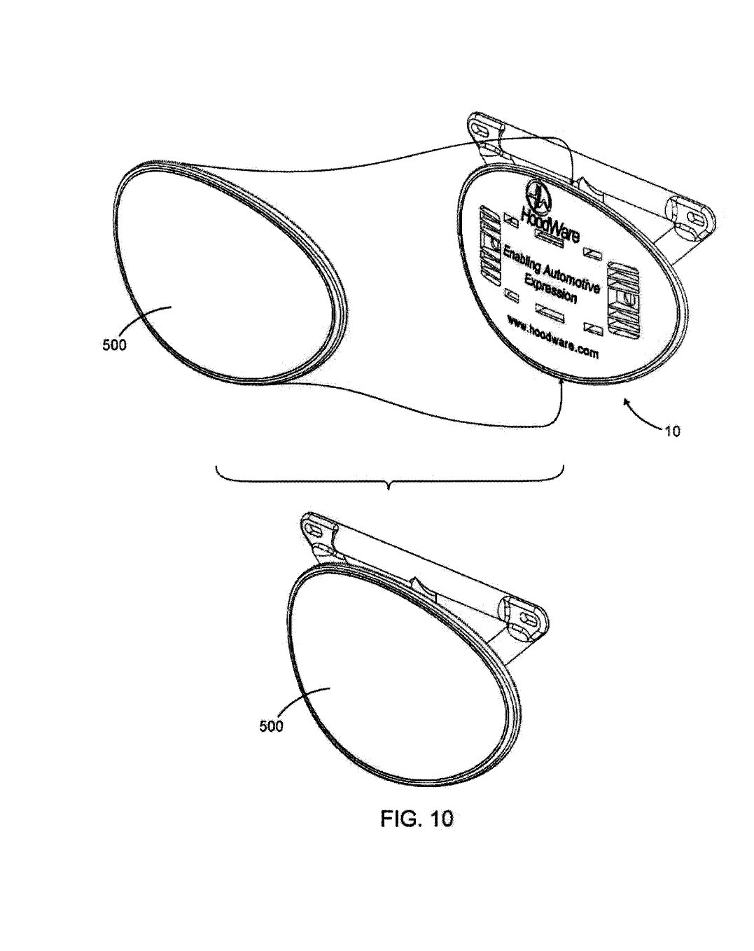

FIG. 10 is a front perspective view of the display system of FIG. 8, showing a display cover.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “display member” can include two or more such structures unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or can not occur, and that the description includes instances where said event or circumstance occurs and instances where it does not.

A display system 10 is disclosed that comprises a multitude of modalities to mount the system to a selective portion of a motor vehicle. The display system comprises a display surface 100 to display any number of graphical images. For instance, the display surface 100 may display a logo, a picture, lettering, symbols, or the like. These images may be printed directly onto the display surface, or they may be adhered to the surface in a variety of known ways. For instance, the images may be printed on a vinyl decal and adhered to the display surface. One skilled in the art can appreciate, there are an abundance of printing mechanisms to carry out the imaging of the display system.

In addition to the display surface, the display system also comprises a mounting assembly 200 configured to selectively mount thereto various portions of the motor vehicle. For example, and not meant to be limiting, the mounting assembly 200 may be mounted to a metallic surface of the vehicle, to a hitch receptacle, to a portion of the vehicle's window or window frame, to a license plate holder, or to a portion of the vehicle grill. In one aspect, the mounting assembly substantially opposes the display surface 100. It may be connected to the body portion of the display assembly or it may be integral therewith.

In one aspect, the mounting assembly of the display member defines at least one magnet cavity 210. As can be seen readily in the figures, a plurality of magnet cavities is also contemplated. In each magnet cavity 210, there may be a magnet disposed therein. The magnet may protrude therefrom the magnet cavity, but it also may be recessed within the magnet cavity. In this way, in use, the magnet does not come into direct contact with the exterior metallic surface of the motor vehicle. This configuration prevents scratching of the exterior surface of the vehicle as the materials of the mounting assembly are generally less abrasive than a magnet. For instance, and not meant to be limiting, the display surface and the mounting assembly 200 may comprise any sufficiently light and rigid materials, such as thermoplastics.

In another aspect, the display member comprises at least one flange 220 protruding therefrom a portion of the mounting assembly. As can readily be seen in FIG. 3, the flange 220 may define at least one strap bore 230 that can be used in conjunction with a substantially elastic elongate member to attach the mounting assembly thereto the front grill of the vehicle. As one in the art can appreciate, conventional bungee cords or other biasing elements may be used. The elastic member 240 may be fed through at least a portion of the strap bore 230, wrapped around a portion of the grill, and attached back to the elastic member 240, to the grill, or to the mounting assembly. In one aspect, a fastener 242 may be attached to one or both ends of the elastic member for ease of use. The fastening member may be a hook or other conventional fastening means.

As mentioned herein above, the mounting assembly 200 may also be configured to attach the display system 10 to the hitch receptacle of the motor vehicle. Hitch receptacles, for the most part, are uniformly sized and shaped. In this aspect, the display member comprises a plurality of flanges protruding therefrom a portion of the mounting assembly and these flanges define a mount cavity 250. In this aspect, a hitch member 300 is configured for selective complimentary insertion into the mount cavity 250, such that a proximal portion 310 of the hitch member 300 slides into the mount cavity. As one skilled in the art can appreciate, the distal portion 330 of the hitch member is configured for complimentary insertion into a hitch receptacle of the motor vehicle.

In yet another aspect, the flanges 220 that define the mount cavity each comprise a sidewall 252 and at least one of the sidewalls defines at least one retention hole 254, as is shown in FIG. 4. In this aspect, the proximal portion of the hitch member comprises at least two lateral bias members 320 configured to bias from a first position, in which the proximal portion of the hitch member is free to slide into the mount cavity, and a second position in which the bias member 320 protrudes therefrom an exterior surface of the proximal portion 310 of the hitch member 300 and into the retention hole 254, thereby preventing the hitch member from being removed from the mount cavity 250. As can be seen, there may be a plurality of strap bores, as well as lateral bias members 320. In order to retain the hitch member into the receptacle, in one aspect, a portion of the distal portion 330 of the hitch member defines a pair of locking holes 322 configured to be coaxial with a pair of locking holes defined therein the hitch receptacle when inserted into the hitch receptacle. In this aspect, a pin may be inserted therethrough the locking holes of the hitch receptacle and the locking holes of the hitch member 300 to secure the hitch member to the hitch receptacle.

As mentioned herein above, the display system may also comprise a license plate adapter 400 for use with a common license plate holder found on the front of most vehicles. The license plate adapter 400 comprises a frame and a pair of flanges 420 extending upwardly away from the frame. In one aspect, the pair of flanges 420 is configured to complementary engages the mount cavity to secure the frame to the display member. In turn, the frame is configured to attach to a license plate holder of the motor vehicle in a conventional manner. As can be seen in the figures, the frame may define two or more bores through which to attach the frame to the license plate holders via screws or bolts.

As discussed herein, the display surface is configured for receipt of a graphic design. While the graphic image does not have to be permanent, it will generally be at least semi permanent, meaning that it may not be easy to remove. In another aspect, the display system may comprise a display cover 500 that can be selectively and removably attached to and substantially covering the display surface of the display member. The display cover 500 may be attached via common means, such as for example, VELCRO, double-sided tape, adhesives, and the like. Alternatively, the display cover may comprise a generally elastic border and may substantially wrap around the display member, akin to how a shower cap works.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

I claim:

1. A display system comprising:
a display member having a display surface and a mounting assembly, wherein the mounting assembly comprises pluralities of means for selectively and releasably mounting the mounting assembly to a selective portion of a motor vehicle.

2. The display system of claim 1, wherein the mounting assembly substantially opposes the display surface.

3. The display system of claim 1, wherein the mounting assembly is integral with the display member.

4. The display system of claim 1, wherein the mounting assembly of the display member defines at least one magnet cavity and the means for mounting the display member onto an exterior metallic surface of the motor vehicle comprises a magnet disposed therein the magnet cavity.

5. The display system of claim 4, wherein the magnet is recessed within the magnet cavity such that, in use, the magnet does not come into direct contact with the exterior metallic surface of the motor vehicle.

6. The display system of claim 1, wherein the display member comprises at least one flange protruding therefrom a portion of the mounting assembly.

7. The display system of claim 6, wherein the at least one flange defines at least one strap bore, and wherein the means for mounting the display member to the motor vehicle comprises at least one substantially elastic elongate member comprising a fastener on at least one of its ends and configured to wrap around a portion of the grill portion of the motor vehicle and therethrough at least a portion of the strap bore to secure the display member to the grill portion of the motor vehicle.

8. The display system of claim 6, wherein the display member comprises a plurality of flanges protruding therefrom a portion of the mounting assembly, the flanges define a mount cavity.

9. The display system of claim 8, further comprising a hitch member, wherein the mount cavity is configured for complimentary receipt of a proximal portion of the hitch member, and wherein a distal portion of the hitch member is configured for complimentary insertion into a hitch receptacle of the motor vehicle.

10. The display system of claim 9, wherein the hitch member and the mount cavity comprise means for selectively and releasable attachment of the hitch member to the display member.

11. The display system of claim 9, wherein the flanges that define the mount cavity each comprise a sidewall, and wherein at least one of the sidewalls defines at least one retention hole.

12. The display system of claim 11, wherein the proximal portion of the hitch member comprises at least two lateral bias members configured to bias from a first position, in which the proximal portion of the hitch member is free to slide into the mount cavity, and a second position in which the bias member protrudes therefrom an exterior surface of the proximal portion of the hitch member and into the retention hole, thereby preventing the hitch member from being removed from the mount cavity.

13. The display system of claim 12, wherein a portion of the distal portion of the hitch member defines a pair of locking holes configured to be coaxial with a pair of locking holes defined therein the hitch receptacle when inserted into the hitch receptacle, such that a pin may be inserted therethrough the locking holes of the hitch receptacle and the locking holes of the hitch member to secure the hitch member to the hitch receptacle.

14. The display system of claim 8, further comprising a license plate adapter comprising a frame and a pair of flanges extending upwardly away from the frame, wherein the pair of flanges is configured to complementary engage the mount cavity to secure the frame to the display member, and wherein the frame is configured to attach to a license plate holder of the motor vehicle.

15. The display system of claim 1, further comprising a display cover selectively and removably attached to and substantially covering the display surface of the display member.

16. A display system comprising:
a display member having a display surface and an mounting assembly oppositely disposed thereon the display member, wherein the mounting assembly comprises:
a means for selectively and releasably mounting the display member onto an exterior metallic surface of a motor vehicle; and
a means for selectively and releasably mounting the display member onto a grill portion of the motor vehicle.

17. The display system of claim 16, further comprising a means for selectively and releasably mounting the display member to a hitch receptacle of the motor vehicle.

18. The display system of claim 16, further comprising means for selectively and releasable mounting the display member to a license plate holder of the motor vehicle.
